(19) United States
(12) Patent Application Publication
(10) Pub. No.: US 2024/0331262 A1
(43) Pub. Date: Oct. 3, 2024

(54) ACCESSIBLE ANIMATION SELECTION AND STYLIZATION IN VIDEO GAMES

(71) Applicant: Electronic Arts Inc., Redwood City, CA (US)

(72) Inventors: Han Liu, Millbrae, CA (US); Jayesh Punjaram Patil, San Jose, CA (US)

(21) Appl. No.: 18/622,780

(22) Filed: Mar. 29, 2024

Related U.S. Application Data
(60) Provisional application No. 63/456,315, filed on Mar. 31, 2023.

(51) Int. Cl. G06T 13/80; A63F 13/55

(52) U.S. Cl. CPC G06T 13/80; A63F 13/55

(57) ABSTRACT

An animation system is configured to accessibly curate selectable animations and/or stylized animations based in part on vocal audio data provided by a user during gameplay of a video game application. The vocal audio data is encoded by way of a machine learning model to produce and/or extract feature embeddings corresponding to the utterances among the vocal audio data. The feature embeddings are used in part to create a list of selectable animations and to create stylized animations that can be displayed to the user. In turn, the animation system enables users to use their voice to personalize their gameplay experience.

### CROSS REFERENCE TO RELATED APPLICATIONS

Any and all applications for which a foreign or domestic priority claim is identified in the Application Data Sheet as filed with the present application are incorporated by reference under 37 CFR 1.57 and made a part of this specification.

### BACKGROUND

As video games grow in size and complexity, the amount of animations among video games grows in unison. As animations grow, it becomes increasingly difficult for users to efficiently and accessibly select and/or stylize one or some animations during gameplay. Accordingly, there is a need for systems and methods that provide an animation system among video games that make animation selection and stylizing more accessible to players.

### BRIEF DESCRIPTION OF THE DRAWINGS

This disclosure will be more fully understood from the following detailed description taken in conjunction with the accompanying drawings, in which:

FIG. 1 is a system diagram of a gaming environment according to an example embodiment;

FIG. 2 is a diagram of a process of matching and stylization animations, according to an example embodiment.

FIG. 3 is a system diagram of training an animation system, according to an example embodiment.

FIG. 4 is a system diagram of animation system, according to an example embodiment;

FIG. 5 is a diagram of an example computing device.

### DETAILED DESCRIPTION

The systems and methods described herein provide an animation system for selecting and stylizing animations among a video game and/or virtual social space based in part on user input data. Advantageously, the animation system disclosed herein automates a curation of animation selections and the stylization of animations by encoding user input data to accessibly display the selection of animations and/or stylized animations during gameplay.

An animation system of a video game application is driven and/or otherwise based in part on user input data, such as voice audio data. A user can provide voice audio data as input data during the runtime (e.g., gameplay) of a video game application to cause and/or inform an animation system to produce and/or display (i) a curation of one or more selectable animations and/or (ii) a stylization one or more animations.

The animation system can be based in part on a “sequence-to-sequence” machine learning model such as a transformer model, as known to a person of skill in the art to be advantageous in the field of natural language processing (NLP). A transformer model of an animation system includes one or more encoders and/or decoders trained to inference (e.g., produce or generate) one or more vectors as output that correspond to one or more embedded features of the voice audio data provided as input data (e.g., to the transformer model) by the user during gameplay.

In turn, the encoders (e.g., transformer model) produce or extract vector representations—or feature embeddings—of the voice audio data provided for the animation system to produce and/or display a set or list of selectable animations for a user to interactively select during gameplay at one or more times proximate to providing the voice audio data.

An animation system uses the feature embeddings produce and/or display a set of one or more selectable animations by (i) using the feature embeddings as input to a machine learning model to generate one or more animations, and/or by (ii) using the feature embeddings as input to match or compare with, or against, feature embeddings of animations among the game data of a video game application. Additionally, an animation system can use the feature embeddings to produce stylized animations, which are an augmentation, alteration, or modification to an animation, such as an animation generated by the animation system and/or an animation among the game data of a video game.

An animation system can include a machine learning model trained to generate animations (commonly known as a neural animation model) from feature embeddings of voice audio data. The neural animation model can be of, or include, a mixture of experts (MOE), an autoencoder, a convolution neural network, a fully connected network, and other models of the like, and combinations thereof, known to those of skill in the art as advantageous for animation generation. For instance, a neural animation model can include any of the models disclosed, described, and/or referenced in U.S. patent application Ser. No. 17/669,927, filed Feb. 11, 2022 and titled “Goal Driven Animation,” the contents of which are incorporated herein by reference in their entirety.

An animation system can match or compare feature embeddings (e.g., vector values) of voice audio data with the feature embeddings of animations stored and/or included among the game data of a video game application (e.g., as animation data, or animation files) to produce a set of one or more selectable animations to display to the user. This matching process is based in part on a distance analysis or distance calculation of the vector values of the respective feature embeddings; such as, for example, a Euclidean distance. As such, animations among the game data of a video game application can be configured to include, as data, embedded features so that the distance analysis can be performed. In some embodiments, an animation system can be configured to produce feature embeddings for the animations of a video game.

Accordingly, the animation generation and matching process of an animation system can be performed during the runtime of a video game application to provide accessible animation selections, which can be presented or displayed to the user for selection by way of an interactive user interface presented during gameplay. A selection of an animation causes the animation system to execute and/or perform the corresponding animation; such as among one or more respective player characters, non-player characters, and other animatable virtual objects among a video game application of the like.

Additionally, the animation system can also use embedded features from voice audio data to produce stylized animations. An embedded feature of the voice audio data can be used in part to scale an aspect or parameter of an animation. As such, one or more vector element values from an embedded feature of the voice audio data can be used as a scalar to modify or alter an intensity, speed, orientation, rotation, direction, trajectory, or other parameter or aspect of an animation during runtime.

For simplicity, the terms “vector”, “feature embeddings” and “embedded features” are used interchangeably herein. As used herein, animation refers to character animation and/or skeletal animations that can be applied to characters, such as player characters, of a video game during gameplay. A video game can include a set or library of animations that can be used or played during runtime. A video game can also include a model for generating animations, interpolating animations, and/or for other animation production or generation of the like as known to those of skill in the art.

### Gaming Environment

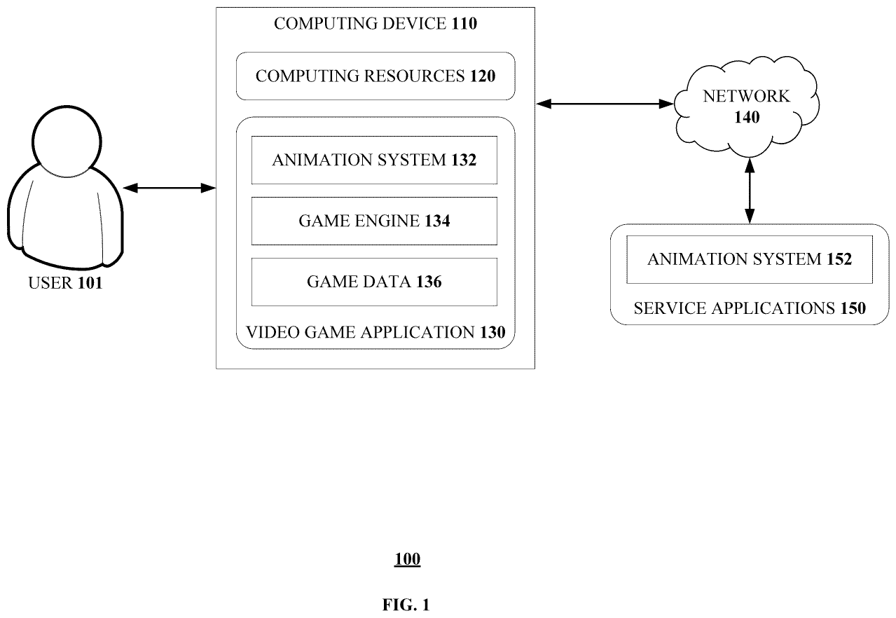

FIG. 1 is a system diagram of a gaming environment 100 according to an example embodiment. As shown in FIG. 1, the environment 100 includes a computing device 110 that is associated with—or operated and/or controlled by—a user 101 (also referred to herein interchangeably as “player” or “player 101”). As described herein, the gaming environment 100 enables users to execute and/or play video games applications (or “video game” in short) that provide an animation system for matching and stylizing animations based in part on user input through their computing devices.

As known to those of skill in the art, user 101 can operate or control the computing device 110, such as for playing a video game application, through inputs provided via input devices of, or associated with, computing device 110. User 101 can provide inputs to the computing device 110 through one or more input devices (e.g., controller, keyboard, mouse, touchscreen, camera, microphone, etc.) associated with the computing device 110. Computing device 110 can output, communicate and/or provide information (e.g., display, render, play audio) to user 101 through one or more output devices (e.g., monitor, screen, touchscreen, speaker, haptics, etc.) associated with computing device 110.

User 101 can be a player and/or an automated agent (hereinafter “agent” in short). As known to a person of ordinary skill in the art, an “agent” can include a machine learning model and/or software to automate or perform one or more tasks (e.g., playing or testing a video game). For instance, agents can function as users 101 and be deployed, controlled, and/or directed by computing device 110 to perform and/or automate one or more tasks in computing devices 110 through techniques known to those of skill in the art.

Computing device 110 can be or include any one or a combination of systems known to those of skill in the art, including, for example, a desktop, laptop, game application platform, game console, virtual reality system, stylized reality system, television set-top box, television, network-enabled kiosk, car-console devices computerized appliance, wearable device (e.g., smart watch, glasses with computing functionality), and wireless mobile devices (e.g., smart phones, PDAs, tablets). The example computing device 110 can store and/or execute computer executable instructions (or code) of applications (or programs or software), such as video game applications, interactive applications, and/or other applications known to those of skill in the art that could include or benefit from the systems and methods described herein.

Computing resources 120 of computing device 110 include hardware and software components that can be used to execute a video game application, among other applications; including, for example, central processing units (CPUs), memory, mass storage, graphics processing units (GPUs), communication or networking components, input devices and/or output devices (I/O devices). It should be understood that the computing device 110 can include any number and/or combination of computing resources; including those described herein and others known to those of skill in the art.

Video game application 130 includes data and software that provides gameplay and other features to users (or “players”) of a video game during execution. For example, executing video game application 130 can cause an instance of the video game to be generated. Each instance can be referred to as a “game session” or “gameplay session”. The game session can be made up of or include one or more virtual interactive environments. A virtual interactive environment can be or include one or more virtual levels, virtual social spaces, and/or graphical user interfaces that can be interacted with or in, for gameplay or socializing. As such, a game session can include, host, or enable—for users—participation and interaction by or with player characters, non-player characters, quests, objectives, and other features, elements, assets, objects or the like known to those of skill in the art.

As illustrated in FIG. 1, by way of example and not limitation, video game application 130 includes animation system 132, game engine 134, and game data 136. As known to a person of ordinary skill in the art, a game engine uses game data (e.g., state data, render data, simulation data, audio data, and other data types of the like) to generate and/or render one or more outputs (e.g., visual output, audio output, and haptic output) for one or more computing devices. In some embodiments, game engine 134 includes underlying frameworks and software that execute game code (e.g., gameplay instructions) of video game application 130 for generating game sessions. In some embodiments, game data 136 includes state data, simulation data, rendering data, audio data, animation data, and other data-including game code-used and/or produced by or among game engine 134 during execution.

Animation system 132 of video game application 130 is software configured to provide animations, animation selection, and animation stylization to video game application 130. As known to a person of ordinary skill in the art, animation system 132 can provide animations to a video game application by a machine learning model that generates, as output, animations during runtime. Alternatively, animation system 132 can include deterministic logic for providing animations during runtime, such as an animation state machine, from a library of animations (e.g., animation data files) among game data 136.

Advantageously, animation system 132 also provides for animation selection and animation stylization during runtime based in part on user input data. For instance, user 101 can provide voice audio data as input from a microphone (e.g., audio input device) communicatively coupled to computing device 110 for video game application 130 and/or animation system 132 to receive and process. Animation system 132 can process the (audio) input data for determining and presenting animation selections and animation stylization during the runtime of a video game.

Network 140 includes any method of private and/or public connectivity, networking, and/or communication between or among hardware devices known in the arts. The network may be or include direct wired connections, Near Field Communication (NFC), a Local Area Network (LAN), a Virtual Private Network (VPN), an internet connection, or other communication methods known to those of skill in the art. As illustrated, network 140 communicatively couples computing device 110 to service applications 150.

Service applications 150 provide services to video game application 130. As known to a person of ordinary skill in the art, service applications are software that provide functionality and/or data to other software applications. Services can be provided remotely over a network (commonly known as a “software as a service” or “SaaS” in short) or locally among a system. It should be understood that service applications 150 operate and/or execute a system and/or computing device(s) with computing resources (commonly known as a server); which can be similar to computing device 110.

The service applications 150 can include “gameplay services” corresponding to one or more aspects or features of a video game application, including matchmaking services, communication services, game state management, data storage, and anti-fraud detection, and other game related services of the like. In turn, the service applications 150 can be used to establish and maintain connections among computing devices, video game applications, and/or users that, at least in part, facilitate gameplay parties, player communications, multiplayer gameplay and other interactions corresponding to a video game application and/or user platform corresponding to video games.

Additionally, service applications 150 can include a video game platform corresponding to video game applications. User accounts of the video game platform include data provided by users, such as a username, which identifies a user among gaming environment 100. The video game platform enables a user account to access and/or manage software and/or services of gaming environment 100 for gameplay, such for multiplayer gameplay and other online gameplay features of the like.

Animation system 152 is software configured to provide animations, animation selection, and animation stylization to video game application 130. In some embodiments, animation system 152 is similar to animation system 132. Additionally, animation system 152 can provide video game application 130 with data to update and/or reconfigure software among animation system 132; such as to one or more modules or machine learning models. For instance, animation system 152 can provide data to animation system 132 corresponding to an updated or retrained machine learning model for generating animations during runtime.

### Process

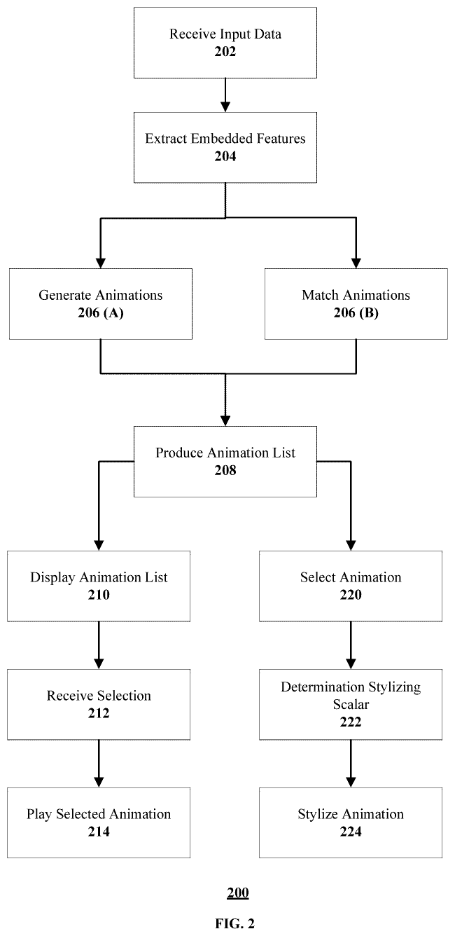

FIG. 2 is a diagram of a process for animation selection and stylization by an animation system, according to an example embodiment. Process 200 corresponds to an animation system of a video game application, similar to animation system 132 and 152 of FIG. 1.

At step 202, an animation system receives input data from a user of a video game application during gameplay. The input data received from the user includes voice audio data provided from a user during gameplay. In some embodiments, a user provides voice audio data as input data to the video game application from a microphone (e.g., audio input device) communicatively coupled to a corresponding computing device. As such, the voice audio data provided by a user may include and/or capture an utterance made by the user during gameplay.

At step 204, an encoder (e.g., transformer model) of an animation system extracts and/or determines features embedded among the voice audio data received. For instance, embedded features among voice audio data include tone, pitch, inflection, volume, and speech or dialogue (e.g., spoken words), among other things. The encoder of the animation system can output and/or represent the embedded features of voice audio data as a vector of real number values.

At step 206 (A), a neural animation model of an animation system can generate animations based in part on the extracted embedded features from step 204. The neural animation model generates inputs based in part one or more of the embedded features from the voice audio data. The generation of animations can further be based in part (e.g., as input to the neural animation mode) on other input data provided by a user, such as control input for gameplay received by an input device, such as a controller, communicatively coupled to a computing device and/or video game application corresponding to the animation system.

Alternatively, or in addition to step 206 (a), at step 206 (B), an animation system uses the output from step 204 (e.g., vector of real values) to match the voice audio data provided at step 202 to one or more animations of a video game. The matching of the voice audio data to animations of a video game corresponds to the comparison of the embedded features (e.g., vectors of real values) of the voice audio data to the embedded features of animation data. As known to a person of ordinary skill in the art, a comparison of embedded features is a calculation of the distance between the corresponding vectors of real values, such as a Euclidean distance. For example, a close distance between the values of the vectors corresponds or correlates to a close similarity between the embedded features, whereas a large distance between the values corresponds or correlates to a large dissimilarity.

A match or comparison made by the animation system at step 206 (B) can correspond to embedded features between voice audio data and animations having a distance within a configurable range and/or threshold (e.g., matching threshold). The animation system can be configured to make any number of matches, including a minimum match and/or a maximum match. In some embodiments, a matching threshold can be dynamically changed (e.g., incremented, or decremented) if a minimum number of matches is not met within or with a matching threshold. In some embodiments, the embedded features of the utterance among the voice audio data can differ from the training data and/or learnings of the transformer model of the animation system, and a subsequent, supplemental, and/or additional model may be used to further correlate the utterance (or embedded features thereof) with the learned embedded features.

At step 208, can produce an animation list including a list or subset of selectable animations based in part on the results of step 206 (A) and/or 206 (B). Thereafter, the animation system can proceed to display the animation list for user selection (steps 210, 212, and 214) and/or stylize an animation (steps 220, 222, and 224).

At step 210, an animation system can display (e.g., prompt) a user for selection of one or more matched animations (from step 206). The displayed prompt can include or be an interactive user interface that displays the animation list produced at step 208 the user. The prompt can be configured to receive input from the user (e.g., user input) for a selection of one or more of the displayed animations among the prompt.

At step 212, an animation system receives one or more selections of an animation displayed among the prompt, such as through user input from an input device communicatively coupled to a computer device and/or video game application, such as a controller.

At step 214, the animation system causes the one or more selected animations to play during runtime. In some embodiments, the animation system causes one or more virtual characters, virtual objects, and/or other animatable virtual entities of the like to perform the animation.

At step 220, an animation system can be configured to select an animation among an animation list from step 208 for stylizing. In some embodiments, an animation system can match to and/or generate one animation for the animation system to stylize and, thereby, omit steps 208 and 220.

At step 222, an animation system determines the value of a scalar to scale (e.g., stylize) an animation by. The scalar can be of a value corresponding to one or more embedded features (e.g., the vector elements thereof) of the voice audio data received. For example, the scalar value can be based in part on an expression embedding (e.g., a type of feature embedding) of the voice audio data.

In some embodiments, a user may provide other forms of input data to the video game application for an animation system to receive, in addition to, voice audio data. For instance, motion data from an input device, such as a gyroscope or accelerometer, may be received as input data for an animation system to receive and/or process for animation selection and/or animation stylization. For example, motion data can be used to determine a scalar value for animation stylization.

At step 224, an animation system stylizes an animation with the scalar determined at step 222. In some embodiments, an animation can be modified or altered to include the stylization prior to the animation being played during runtime. In some embodiments, the stylization of an animation occurs at runtime when the animation is played, such that stylized animation does not need to be stored, saved, and/or otherwise captured among the game data of a video game application for it to be played.

For instance, the value of the scalar can scale (e.g., stylize) a “walking” animation to cause the animation to be performed quicker or slower, based in part on the value determined, by using the scalar to scale the animation speed. As an illustrative example, if the expression embedding of voice audio data corresponds to an “excited” expression among the utterance captured in the voice audio data, the walking animation can be stylized to be performed faster or quicker than normal by having the animation speed multiplied by the scalar. In some embodiments, the stylization of an animation occurs automatically without user input, control, or direction, after the receiving voice audio data form the user.

As a result, process 200 advantageously provides users a curated list of selectable animations and/or stylizes animations based in part on their vocal input. This, in turn, provides an accessible way for users to have a personalized experience in gameplay, if a user chooses to enable such features of an animation system among a video game application.

In some embodiments, process 200 and the corresponding animation system are configured as a tool among a video game development application for developing video game applications and corresponding services and content thereto. The animation system, as a tool, can be used by developers to aid their development of animations for a video game, such that the developers can use voice audio input to assist the generation of animations for a video game, and to create animation state machines based in part on the animations lists produced.

The steps and process of FIG. 2 can be associated with one or more hardware and/or software modules configured with computer-executable instructions. A person of ordinary skill in the art would recognize and appreciate how the proceeding process may be configured in many ways, such that one or more of steps are performed before, after, or simultaneously among other steps, and/or otherwise omitted or substituted in whole or in part.

### Animation Matching and Stylization System

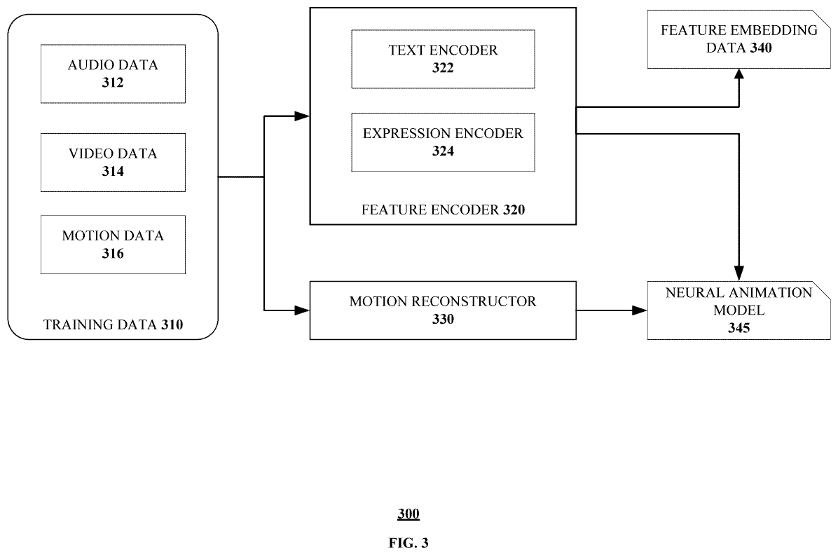

FIG. 3 is a system diagram of the training of an animation system, according to an example embodiment. Diagram 300 corresponds to a machine learning model of an animation system of a video game application, similar to animation system 132 and 152 of FIG. 1.

An animation system can be trained to (i) learn feature embeddings from training data, (ii) reconstruct motion from training data, and (iii) generate animations. Once trained, the animation system can be used to generate animations during the runtime of a video game, and the learned feature embeddings can be used in part to provide feature embeddings to animations.

Training data 310 includes a variety of data types to train a machine learning model of an animation system. Training data can include audio data 312, video data 314, and motion data 316. Each data type among training data can be used by one or more machine learning models for training. In some embodiments, some data types include or correspond to data types. For example, motion data 316 can include motion capture data from a motion capture session, which can further include or have corresponding video data and audio data, in addition to the motion capture data itself.

Feature Encoder 320 corresponds to one or more transfer models of an animation system, trained to learn feature embeddings from training data 310. Feature encoder 320 can be configured in part to learn expression embedding from auditory data and/or transcripts of auditory data, such as text or dialogue embedding and expression embedding. As such, a text encoder 322 and expression encoder 324 can be modules among feature encoder 320 configured to learn text embedding and expression embedding from data 310, respectively. For example, audio and/or audio transcript data from or corresponding to audio data 312, video data 314, and motion data 316 can be used in part to train encoders 322 and 324. In some embodiments, each encoder (322 and 324) is a separate transformer model and/or separate encoder among a transformer model of an animation system.

Motion Reconstructor 330 is a machine learning model trained to learn 3D pose estimation. The model of motion reconstructor 330 can be a convolutional neural network trained on video, image, or motion data types to learn 3D pose estimates. As such, video data 314 and motion data 316 can be provided to the motion reconstructor 330 to train its 3D pose estimation learnings.

Neural animation model 345 is trained to generate animations based in part on the results of feature encoder 320 and motion reconstructor 330. The 3D poses estimates provided from motion reconstructor 330 provide neural animation model training data for learning to generate skeletal animations. Additionally, the feature embedding data 340 provided by feature encoder 320 enables neural animation model 345 to learn and make associations between the embedded features and the generated animations produced.

For instance, when training data 310 includes audio data 312 that corresponds to video data 314 and/or motion data 316, neural animation model 345 can make associations of embedded features to animations (e.g., generate animations with embedded features) throughout the training process, as each audio, video, and/or motion data would include corresponding data of the other data types to learn the associations of embedded features from.

Furthermore, once trained, the feature encoder 320 can provide and/or produce-through inference with corresponding input data-feature embedding data 340 to existing animations that lack embedded features. In this way, an existing animations can be embedded with features so they can be matched with the embedded features extracted from voice audio data provided by a user to an animation system at the runtime of a video game: as described among the present disclosure, such as the description of FIG. 1 and FIG. 2.

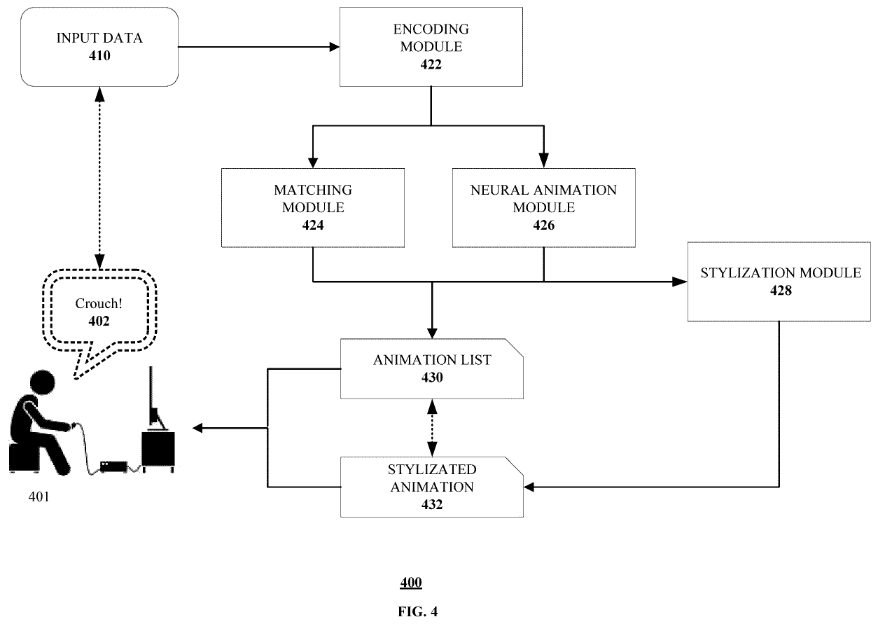

FIG. 4 is a system diagram of the inference of an animation system, according to an example embodiment. Diagram 400 corresponds to an animation system of a video game application, similar to animation system 132 and 152 of FIG. 1.

As a non-limiting illustrative example, user 401 can make utterance 402, in which the user is exclaiming and/or saying “Crouch!” aloud in response and as a reaction to gameplay to convey an intended action for a player character of the video game. As such, an animation system, if enabled among the video game application by the user, can receive the utterance as input data 410, as voice audio data. In some embodiments, input data provided to a controller (e.g., input device) such as button presses, and motion data is also included among input data 410.

Encoding module 422 includes a trained feature encoder similar to feature encoder 320 of FIG. 3 can receive input data 410 to produce and/or extract embedded features from input data 410.

Matching module 424 is configured with instruction to perform a distance analysis on the embedded features output from encoding module 422. The distance analysis can be a Euclidean distance between the embedded features from input data 410 and the animations among a set or a library of animations of the video game application played by user 401: as described among the present disclosure, such as the description FIG. 2. Thereafter, the matching module 424 can be configured to include a fixed number of closest matching (e.g., of a close distance result from the Euclidean distance analysis) to include among a list of selectable animations 430. The animations included among animation list 430 are, in turn, a dynamically curated subset of animations of the video game application that correspond to the embedded features present among input data 410.

Neural animation module 426 is configured with a trained neural animation network for generating animations during runtime: as described among the present disclosure, such as the description FIG. 2 and FIG. 3. As such, neural animation module 426 can receive control input data from input data 410 and/or embedded features from encoding module 422 as input to generate animation during gameplay. In some embodiments, the generated animations can be included among animation list 430.

Additionally, stylization module 428 is configured to stylize animations through scaling one or more parameters of animation: as described among the present disclosure, such as the description FIG. 2. The stylized animations 432 can be included in the animation list 430.

Once the animation list 430 and/or stylized animation 432 are produced, the animation system can cause them to be displayed to the user: as described among the present disclosure, such as the description FIG. 2.

### Computing Device

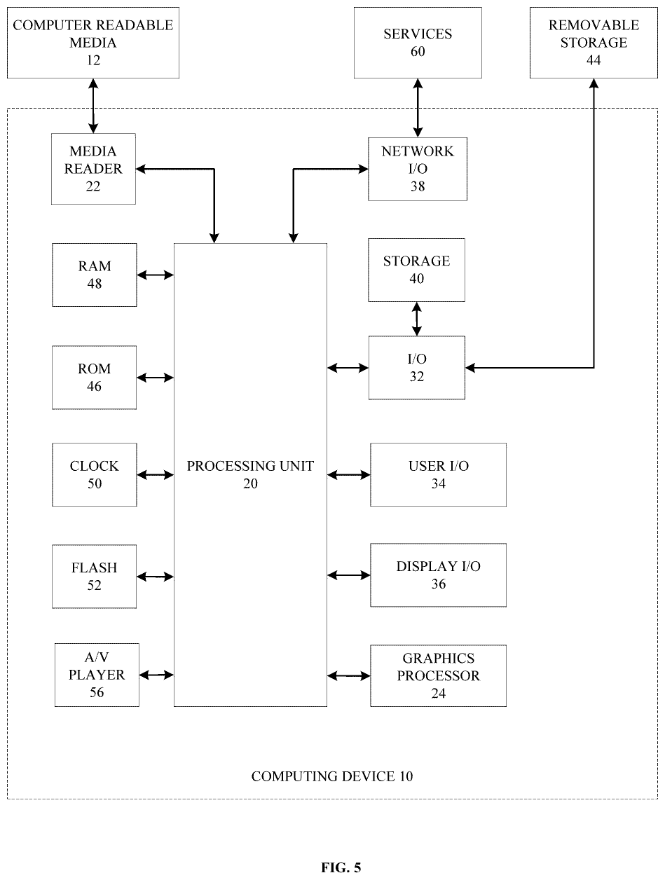

FIG. 5 illustrates an example embodiment of a computing device 10. In some embodiments, some or all of the aforementioned systems and computing devices—such as computing device 110 of FIG. 1—are similar to computing device 10. The example computing device 10 can store and/or execute computer executable instructions (or code) of applications (or programs or software), such as video game applications, interactive applications, and/or other applications known to those of skill in the art that could include or benefit from the systems and methods described herein.

Computing device 10 can be or include any one or a combination of systems known to those of skill in the art, including, for example, a desktop, laptop, game application platform, game console, virtual reality system, stylized reality system, television set-top box, television, network-enabled kiosk, car-console devices, computerized appliance, wearable device (e.g., smart watch, glasses with computing functionality), and wireless mobile devices (e.g., smart phones, PDAS, tablets) and other general-purpose computing devices known to those of skill in the art.

As shown, computing device 10 includes processing unit 20 that interacts with other components of the computing device 10 and external components. A media reader 22 communicates with computer readable media 12. The media reader 22 may be an optical disc reader capable of reading optical discs, such as DVDs or Blu Ray discs, or any other type of reader that can receive and read data from computer readable media 12. One or more of the computing devices may be used to implement one or more of the systems disclosed herein.

Computing device 10 may include a graphics processor 24. In some embodiments, the graphics processor 24 is integrated into the processing unit 20, such that the graphics processor 24 may share Random Access Memory (RAM) with the processing unit 20. Alternatively, or in addition, the computing device 10 may include a discrete graphics processor 24 that is separate from the processing unit 20. In some such cases, the graphics processor 24 may have separate RAM from the processing unit 20. Computing device 10 might be a video game console device, a general-purpose laptop or desktop computer, a smart phone, a tablet, a server, or other suitable system for executing software among graphics processor 24, such as a video game application.

Computing device 10 also includes various components for enabling input/output, such as an I/O 32, a user I/O 34, a display I/O 36, and a network I/O 38. I/O 32 interacts with storage element 40 and removable storage media 44 to provide storage for computing device 10. Processing unit 20 can communicate through I/O 32 to store data. In addition to storage 40 and removable storage media 44, computing device 10 is also shown including ROM (Read-Only Memory) 46 and RAM 48. RAM 48 may be used for data that is accessed frequently during execution of software.

User I/O 34 is used to send and receive commands between processing unit 20 and user devices, such as keyboards or game controllers. In some embodiments, the user I/O can include a touchscreen. The touchscreen can be a capacitive touchscreen, a resistive touchscreen, or other type of touchscreen technology that is configured to receive user input through tactile inputs from the user. Display I/O 36 provides input/output functions that are used to display images. Network I/O 38 is used for input/output functions for a network (e.g., receiving and sending network data communications). Network I/O 38 may be used during execution of software applications by computing device 10; such as when a video game application communicates with a game server over a network.

Display output signals produced by processing unit 20 and/or graphics processor 24 can be sent to display by display I/O 36, including signals for displaying visual content produced by computing device 10; such as display output rendered by a video game application, including graphics, GUIs, video, and/or other visual content. Computing device 10 may comprise one or more integrated displays configured to receive display output signals produced by display I/O 36. According to some embodiments, display output signals produced by display I/O 36 may also be output to one or more display devices external to computing device 10, such as display 16.

The computing device 10 can also include other features, such as a clock 50, flash memory 52, and other components. An audio/video player 56 might also be used to play a video sequence, such as a movie or other media as known to those of ordinary skill in the art. An audio/video player 56 may include or use software for encoding or decoding media for playback.

Computer executable instructions, applications, programs, or code (e.g., software) can be stored in ROM 46, RAM 48, media 12, and/or storage 40 (which might comprise hard disk, other magnetic storage, optical storage, other non-volatile storage or a combination or variation of these). Part of the program code can be stored in ROM that is programmable (ROM, PROM, EPROM, EEPROM, and so forth), part of the program code can be stored in storage 40, and/or on removable media such as media 12 (which can be a CD-ROM, cartridge, memory chip or the like, or obtained over a network or other electronic channel as needed). In general, applications can be found embodied in a tangible non-transitory signal-bearing medium.

Random access memory (RAM) 48 (and possibly other storage) is usable to store variables and other processor data as needed. RAM is used and holds data that is generated during the execution of an application and portions thereof might also be reserved for frame buffers, application state information, and/or other data needed or usable for interpreting user input and generating display outputs. Generally, RAM 48 is volatile storage and data stored within RAM 48 may be lost when the computing device 10 is turned off or loses power.

As computing device 10 reads media 12 and provides an application, information may be read from media 12 and stored in a memory device, such as RAM 48. Additionally, data from storage 40, ROM 46, services 60 accessed via a network (not shown), or removable storage media 46 may be read and loaded into RAM 48. Although data is described as being found in RAM 48, it will be understood that data does not have to be stored in RAM 48 and may be stored in other memory accessible to processing unit 20 or distributed among several media, such as media 12 and storage 40.

The disclosed subject matter can include an apparatus for performing the operations herein. This apparatus may be specially constructed for the required purposes, or it may comprise a general-purpose computer selectively activated or reconfigured by an application stored and/or executed by computing device 10. Such an application may be stored in a non-transitory computer readable medium, such as, but not limited to, any type of disk including optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The disclosed subject matter may include a non-transitory computer readable medium having stored thereon applications or instructions, which may be used (e.g., executed) to instruct a system or computing devices to perform a process according to the disclosed subject matter. A non-transitory computer readable medium includes any mechanism for storing or transmitting information in a form readable by a computing device and other systems of the like known to those of skill in the art.

The applications or instructions of computing device 10 can be stored and/or executed among a local environment and/or among in a distributed environment of computing devices, as known to those of skill in the art. Different applications can include varying instructions, components, graphical configurations, and/or data for supporting their runtime execution on different hardware (e.g., different types of computing devices).

A locally executed application does not rely on or use an external computing device (e.g., a system other than computing device 10) to execute the application. In some instances, a locally executable video game application can communicate with external systems or devices, such as external servers, to retrieve information associated with the video game, such as game patches, game authentication, cloud saves, user account data, previously trained model data, or other features.

In distributed implementations, computing device 10 may execute portions of a video game application, while other systems or devices such as external servers execute other portions of the video game application. For instance, massively multiplayer online role-playing games (MMORPGs) include client portions (e.g., video game application) of the video game executed by computing devices of or corresponding to users or players, and server portions executed by one or more servers. It should be understood that applications described herein can be a locally executable game or a distributed application.

The present disclosure may use machine learning. Machine learning is a subfield of artificial intelligence, which, to persons of ordinary skill of the art, corresponds to underlying algorithms and/or frameworks (commonly known as “neural networks” or “machine learning models”) that are configured and/or trained to perform and/or automate one or more tasks or computing processes. For simplicity, the terms “neural networks” and “machine learning models” can be used interchangeably and can be referred to as either “networks” or “models” in short.

The present disclosure may use deep learning. Deep learning is a subfield of artificial intelligence and machine learning, which, to persons of ordinary skill of the art, corresponds to multilayered implementations of machine learning (commonly known as “deep neural networks”). For simplicity, the terms “machine learning” and “deep learning” can be used interchangeably.

As known to a person of ordinary skill in the art, machine learning is commonly utilized for performing and/or automating one or more tasks such as identification, classification, determination, adaptation, grouping, and generation, among other things. Common types (e.g., classes or techniques) of machine learning include supervised, unsupervised, regression, classification, reinforcement, and clustering, among others.

Among these machine learning types are a number of model implementations, such as linear regression, logistic regression, evolution strategies (ES), convolutional neural networks (CNN), deconvolutional neural networks (DNN), generative adversarial networks (GAN), recurrent neural networks (RNN), and random forest, among others. As known to a person of ordinary skill in the art, one or more machine learning models can be configured and trained for performing one or more tasks at runtime of the model.

As known to a person of ordinary skill in the art, the output of a machine learning model is based at least in part on its configuration and training data. The data that models are trained on (e.g., training data) can include one or more data types. In some embodiments, the training data of a model can be changed, updated, and/or supplemented throughout training and/or inference (i.e., runtime) of the model.

The systems, methods, and/or computing devices of the present disclosure can include machine learning modules. A “machine learning module” is a software module and/or hardware module including computer-executable instructions to configure, train, and/or deploy (e.g., execute) one or more machine learning models.

Some aspects of the present disclosure include subject matter corresponding to the gameplay of video game applications. As known to a person of ordinary skill in the art, the gameplay of a video game is commonly known as occurring among a game session within one or more instances of one or more virtual interactive environments. The gameplay of a video game provides interactivity with one or more aspects of a video game.

A game session may include a number of player characters and/or non-player characters. As known to those of skill in the art, player characters are character models that can be controlled or directed (at least primarily) by users or players through inputs at their respective computing devices, and can perform gameplay actions or commands. “Non-player characters” (also referred to herein as “NPCs”) are characters that are not or cannot be controlled and/or directed (primarily by users or players). Rather, NPCs can be configured with computer executable instructions to perform one or more gameplay tasks and/or actions, with and/or without the need for input or interaction from a user/player or player character.

A game session may include a number of player objects. Player objects can refer to controllable objects, or models, used to facilitate or enable gameplay or other in-game actions. Player objects may be, for example, vehicles, vessels, aircraft, ships, tiles, cards, dice, pawns, and other in-game items of the like known to those of skill in the art. In some embodiments, a user or player can control or direct one or more player objects in a game session, including, in some instances, by controlling player characters which in turn causes the objects to be controlled.

For simplicity, player characters and player objects disclosed are collectively referred to herein as player characters in some embodiments. It should be understood that, as used herein, “controllable” refers to the characteristic of being able and/or configured to be controlled and/or directed (e.g., moved, modified, etc.) by a player or user through one or more input means, such as a controller or other input device, by a player or user. As known to a person of ordinary skill in the art, player characters include character models configured to receive input.

Some aspects of the present disclosure include subject matter corresponding to the data of video game applications. As known to a person of ordinary skill in the art, game data is data corresponding to one or more aspects of a video game application. Game data includes data such as state data, simulation data, rendering data, digital assets, and other data of the like.

State data is commonly known as data describing a state of a player character, virtual interactive environment, and/or other virtual objects, actors, or entities—in whole or in part—at one or more instances or periods of time during a game session of a video game. For example, state data can include the current location and condition of one or more player characters among a virtual interactive environment at a given time, frame, or duration of time or number of frames.

Simulation data is commonly known as the underlying data corresponding to simulation (e.g., physics and other corresponding mechanics) to drive the simulation of a model or object in a game engine. For example, simulation data can include the joint and structural configuration of a character model and corresponding physical forces or characteristics applied to it at instance or period of time during gameplay, such as a “frame”, to create animations, among other things.

Render Data is commonly known as the underlying data corresponding to rendering (e.g., visual and auditory rendering) aspects of a game session, which are rendered (e.g., for output to an output device) by a game engine. For example, render data can include data corresponding to the rendering of graphical, visual, auditory, and/or haptic output of a video game, among other things.

Game data can also include digital game assets. For instance, game assets can include virtual objects, character models, actors, entities, geometric meshes, textures, terrain maps, animation files, audio files, digital media files, font libraries, visual effects, and other digital assets commonly used in video games of the like.

In some embodiments, a game session is based in part on game data. During a game session, one or more aspects of gameplay (e.g., rendering, simulation, state, gameplay actions of player characters) uses, produces, generates, and/or modifies game data. Likewise, gameplay events, objectives, triggers, and other aspects, objects, or elements of the like also use, produce, generate, and/or modify game data.

Game data may be updated, versioned, and/or stored periodically as a number of files to a computing device. Additionally, game data, or copies and/or portions thereof, can be stored, referenced, categorized, or placed into a number of buffers or storage buffers. A buffer can be configured to capture particular data, or data types, of game data for processing and/or storage. For simplicity, the terms “data”, “game data”, “game data”, “state data”, “simulation data”, and “render data” can be used interchangeably to refer to the data of, or corresponding to, a video game.

Some aspects of the present disclosure include subject matter corresponding to video games, including video game components corresponding to the software of a video game. As known to a person of ordinary skill in the art, game code is software defining the gameplay, features, and aspects of a video game whereas a game engine provides underlying frameworks and software that support and facilitate execution of the game code (e.g., gameplay)

As a non-limiting descriptive example, a game engine includes, among other things, a renderer, simulator, and stream layer. A game engine uses game data (e.g., state data, render data, simulation data, audio data, and other data types of the like) to generate and/or render one or more outputs (e.g., visual output, audio output, and haptic output) for one or more computing devices. In some embodiments, a game engine is a distributable computer executable runtime portion of a development client, such as a video game development engine.

A renderer is a graphics framework that manages the production of graphics corresponding to lighting, shadows, textures, user interfaces, and other effects to game assets of the like among a game engine. A simulator refers to a framework that manages simulation aspects corresponding to physics and other corresponding mechanics used in part for animations and/or interactions of gameplay objects, entities, characters, lighting, gasses, and other game assets or effects of the like. A stream layer is a software layer that allows a renderer and simulator to execute independently of one another among a game engine by providing a common execution stream for renderings and simulations to be produced and/or synchronized (e.g., scheduled) at and/or during runtime.

A game engine also includes an audio engine or audio renderer that produces and synchronizes audio playback with or among the common execution of a stream layer. For example, an audio engine of a game engine can use game data to produce audio output and/or haptic output from game data.

As used herein in some embodiments, video game applications can also use and/or include Software Development Kits (SDKs), Application Program Interfaces (APIs), Dynamically Linked Libraries (DLLs), and other software libraries, components, modules, shims, or plugins that provide and/or enable a variety of functionality; such as—but not limited to—graphics, audio, font, or communication support, establishing and maintaining service connections, performing authorizations, and providing anti-cheat and anti-fraud monitoring and detection, among other things.

Some portions of the detailed descriptions above are presented in terms of symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated (e.g., among a computing device). It has proven convenient at times, principally for reasons of common usage, to refer to these signals as bits, values, elements, symbols, characters, terms, numbers, or the like.

One set of example embodiments of the disclosure can be described by the following clauses:
Clause 1. A system comprising: at least one processor; and at least one memory device, wherein the at least one memory device is communicatively coupled to the at least one processor, the at least one memory device storing computer-executable instructions, wherein execution of the computer-executable instructions by the at least one processor causes the at least one processor to: receive voice audio data during gameplay of a video game from a player; extract one or more feature embeddings from the voice audio data; determine, from among a set of character animations, a subset of character animations based at least in part on the one or more feature embeddings extracted from the voice audio data; prompt, via an interactive user interface, selection of a character animation from among the subset of character animations, the interactive user interface configured to display the character animations of the subset; receive a selection of a first character animation; and cause a player character of the video game to perform the first character animation during gameplay.
Clause 2. The system of clause 1, wherein the voice audio data received is an utterance made external to the video game by the player.
Clause 3. The system of clause 1, wherein the one or more feature embeddings are extracted by a machine learning model, the machine learning model including encoders trained on training data comprising at least audio data and video data.
Clause 4. The system of clause 1, wherein the determination of the subset of character animations is based in part on a Euclidean distance analysis.
Clause 5. The system of clause 1, wherein the computer-executable instructions further configure the at least one processor to render the interactive user interface for display during runtime of the video game at a time proximate to when the voice audio data is received.
Clause 6. The system of clause 1, wherein the one or more feature embeddings are used to stylize a character animation among the subset.
Clause 7. A computer implemented method comprising: receiving voice audio data during gameplay of a video game from a player; extracting one or more feature embeddings from the voice audio data; determining, from among a set of character animations, a subset of character animations based at least in part on the one or more feature embeddings extracted from the voice audio data; prompting, via an interactive user interface, selection of a character animation from among the subset of character animations, the interactive user interface configured to display the character animations of the subset; receiving a selection of a first character animation; and causing a player character of the video game to perform the first character animation during gameplay.
Clause 8. The computer implemented method of clause 7, wherein the voice audio data received is an utterance made external to the video game by the player.
Clause 9. The computer implemented method of clause 7, wherein the one or more feature embeddings are extracted by a machine learning model, the machine learning model including encoders trained on training data comprising at least audio data and video data.
Clause 10. The computer implemented method of clause 7, wherein the determination of the subset of character animations is based in part on a Euclidean distance analysis.
Clause 11. The computer implemented method of clause 7 further comprising rendering the interactive user interface for display during runtime of the video game at a time proximate to when the voice audio data is received.
Clause 12. The computer implemented method of clause 7, wherein the one or more feature embeddings are used to stylize a character animation among the subset.
Clause 13. A non-transitory computer readable medium storing computer-executable instructions, wherein, when executed, the computer-executable instructions configure at least one processor to: receive voice audio data during gameplay of a video game from a player; extract one or more feature embeddings from the voice audio data; determine, from among a set of character animations, a subset of character animations based at least in part on the one or more feature embeddings extracted from the voice audio data; prompt, via an interactive user interface, selection of a character animation from among the subset of character animations, the interactive user interface configured to display the character animations of the subset; receive a selection of a first character animation; and cause a player character of the video game to perform the first character animation during gameplay.
Clause 14. The non-transitory computer readable medium of clause 13, wherein the voice audio data received is an utterance made external to the video game by the player.
Clause 15. The non-transitory computer readable medium of clause 13, wherein the one or more feature embeddings are extracted by a machine learning model, the machine learning model including encoders trained on training data comprising at least audio data and video data.
Clause 16. The non-transitory computer readable medium of clause 13, wherein the determination of the subset of character animations is based in part on a Euclidean distance analysis.
Clause 17. The non-transitory computer readable medium of clause 13, wherein the computer-executable instructions further configure the at least one processor to render the interactive user interface for display during runtime of the video game at a time proximate to when the voice audio data is received.
Clause 18. The non-transitory computer readable medium of clause 13, wherein the one or more feature embeddings are used to stylize a character animation among the subset.

Certain example embodiments are described above to provide an overall understanding of the principles of the structure, function, manufacture and use of the devices, systems, and methods described herein. One or more examples of these embodiments are illustrated in the accompanying drawings. Those skilled in the art will understand that the descriptions herein and the accompanying drawings are intended to be illustrative, and not restrictive. Many other implementations will be apparent to those of skill in the art based upon the above description. Such modifications and variations are intended to be included within the scope of the present disclosure. The scope of the present disclosure should, therefore, be considered with reference to the claims, along with the full scope of equivalents to which such claims are entitled. The features illustrated or described in connection with one exemplary embodiment may be combined with the features of other embodiments. In some instances, well-known structures and devices are shown in block diagram form, rather than in detail, in order to avoid obscuring the disclosed subject matter.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

What is claims is:

1. A system comprising:
at least one processor; and
at least one memory device, wherein the at least one memory device is communicatively coupled to the at least one processor, the at least one memory device storing computer-executable instructions, wherein execution of the computer-executable instructions by the at least one processor causes the at least one processor to:
receive voice audio data during gameplay of a video game from a player;
extract one or more feature embeddings from the voice audio data;
determine, from among a set of character animations, a subset of character animations based at least in part on the one or more feature embeddings extracted from the voice audio data;
prompt, via an interactive user interface, selection of a character animation from among the subset of character animations, the interactive user interface configured to display the character animations of the subset;
receive a selection of a first character animation; and
cause a player character of the video game to perform the first character animation during gameplay.

2. The system of claim 1, wherein the voice audio data received is an utterance made external to the video game by the player.

3. The system of claim 1, wherein the one or more feature embeddings are extracted by a machine learning model, the machine learning model including encoders trained on training data comprising at least audio data and video data.

4. The system of claim 1, wherein the determination of the subset of character animations is based in part on a Euclidean distance analysis.

5. The system of claim 1, wherein the computer-executable instructions further configure the at least one processor to render the interactive user interface for display during runtime of the video game at a time proximate to when the voice audio data is received.

6. The system of claim 1, wherein the one or more feature embeddings are used to stylize a character animation among the subset.

7. A computer implemented method comprising:
receiving voice audio data during gameplay of a video game from a player;
extracting one or more feature embeddings from the voice audio data;
determining, from among a set of character animations, a subset of character animations based at least in part on the one or more feature embeddings extracted from the voice audio data;
prompting, via an interactive user interface, selection of a character animation from among the subset of character animations, the interactive user interface configured to display the character animations of the subset;
receiving a selection of a first character animation; and
causing a player character of the video game to perform the first character animation during gameplay.

8. The computer implemented method of claim 7, wherein the voice audio data received is an utterance made external to the video game by the player.

9. The computer implemented method of claim 7, wherein the one or more feature embeddings are extracted by a machine learning model, the machine learning model including encoders trained on training data comprising at least audio data and video data.

10. The computer implemented method of claim 7, wherein the determination of the subset of character animations is based in part on a Euclidean distance analysis.

11. The computer implemented method of claim 7 further comprising rendering the interactive user interface for display during runtime of the video game at a time proximate to when the voice audio data is received.

12. The computer implemented method of claim 7, wherein the one or more feature embeddings are used to stylize a character animation among the subset.

13. A non-transitory computer readable medium storing computer-executable instructions, wherein, when executed, the computer-executable instructions configure at least one processor to:
receive voice audio data during gameplay of a video game from a player;
extract one or more feature embeddings from the voice audio data;
determine, from among a set of character animations, a subset of character animations based at least in part on the one or more feature embeddings extracted from the voice audio data;
prompt, via an interactive user interface, selection of a character animation from among the subset of character animations, the interactive user interface configured to display the character animations of the subset;
receive a selection of a first character animation; and
cause a player character of the video game to perform the first character animation during gameplay.

14. The non-transitory computer readable medium of claim 13, wherein the voice audio data received is an utterance made external to the video game by the player.

15. The non-transitory computer readable medium of claim 13, wherein the one or more feature embeddings are extracted by a machine learning model, the machine learning model including encoders trained on training data comprising at least audio data and video data.

16. The non-transitory computer readable medium of claim 13, wherein the determination of the subset of character animations is based in part on a Euclidean distance analysis.

17. The non-transitory computer readable medium of claim 13, wherein the computer-executable instructions further configure the at least one processor to render the interactive user interface for display during runtime of the video game at a time proximate to when the voice audio data is received.

18. The non-transitory computer readable medium of claim 13, wherein the one or more feature embeddings are used to stylize a character animation among the subset.
